(19) United States
(12) Patent Application Publication
(10) Pub. No.: US 2009/0167865 A1
(43) Pub. Date: Jul. 2, 2009

(54) Photographic object recognition correction

(76) Inventor: William Ralph Jones, JR., Oakland Park, FL (US)

Correspondence Address: William Ralph Jones Jr., PO. Box 23609, Oakland Park, FL, 33307-3609, US

(21) Appl. No.: 12/317,379

(22) Filed: Dec. 22, 2008

Related U.S. Application Data
(60) Provisional application No. 61/008,914, filed on Dec. 26, 2007.

(51) Int. Cl. H04N 7/18; G06K 9/00

(52) U.S. Cl. 348/149; 382/105; 348/E07.085

(57) ABSTRACT

This invention describes a set of simple yet novel methods for capturing photographs of moving objects that are constrained to lie within a relatively flat object region that is not necessarily perpendicular to the axis of the camera lens. Using these methods, one can select a focal plane and an object region that is not that of a normal camera, and, when objects are constrained to move within that object region, one can successfully photograph them no matter where they appear within the field without losing focus.

### BACKGROUND OF THE INVENTION

Presently, the successful capture of well-focused images of objects relies upon their being constrained to exist within a fixed region of an object plane, with this plane being normal to an axis running through the center of the lens of the camera. I will call this the “object region” There are applications, both using film and video imaging, that require the camera to be positioned so that this axis is not normal to the object plane, that is, the plane in which objects are constrained to exist. This means the camera sees an object plane that is at the center of a flat sandwich of sorts, the object region, and objects constrained to this region are in focus, objects outside this region lacking sufficient focus to be useful.

An example of this situation is the videography of auto tags in poor lighting conditions and at large distances. Typically, a telephoto lens is employed. Since automobiles travel in public streets, and those who wish to deploy a device for capturing images of the passing tags in a reliable manner are not free to mount cameras in the streets, they must mount their cameras to the side of the streets.

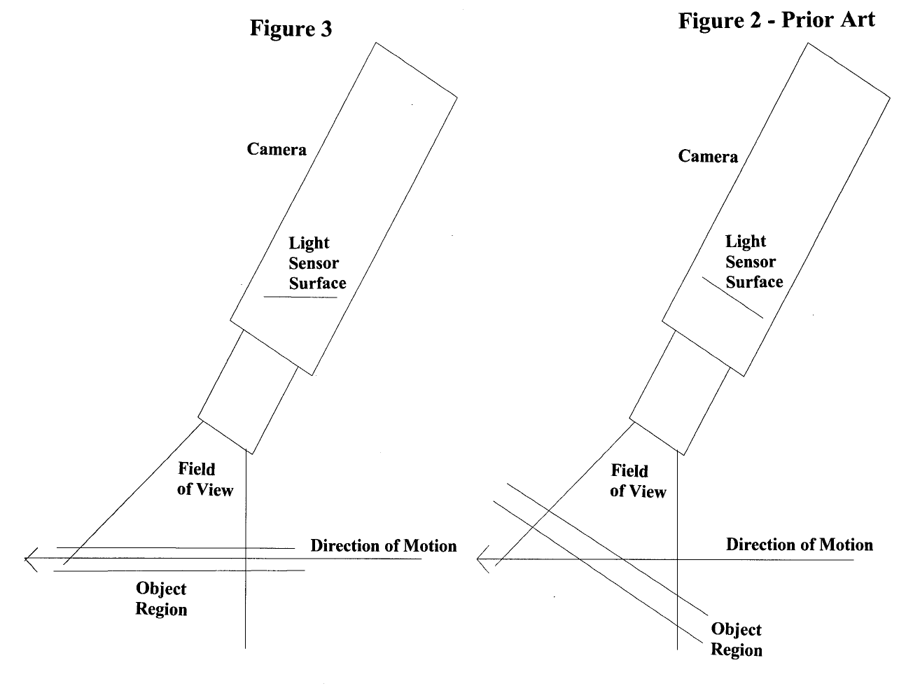

This user cannot point the camera perpendicular to the direction of the street, since if he did he would be looking along the length of the tag and be unable to see the face of the tag, which contains the desired information. Such a user must mount the camera so that it looks at the street at an angle significantly different from 90 degrees with the street, or, in other words, so that the axis through the center of the lens is normal to an object plane that is not parallel to the street, and thus is not parallel to the direction in which the tag face is travelling. The result is that the center of the object region intersects the line in parallel to the street that represents the most frequent position along the street's width at only one point. Tags to the left of this point begin to go out of focus as they move out of the ordinary camera's object region, and tags to the right also begin to go out of focus in the same manner. This situation is illustrated in FIG. 2.

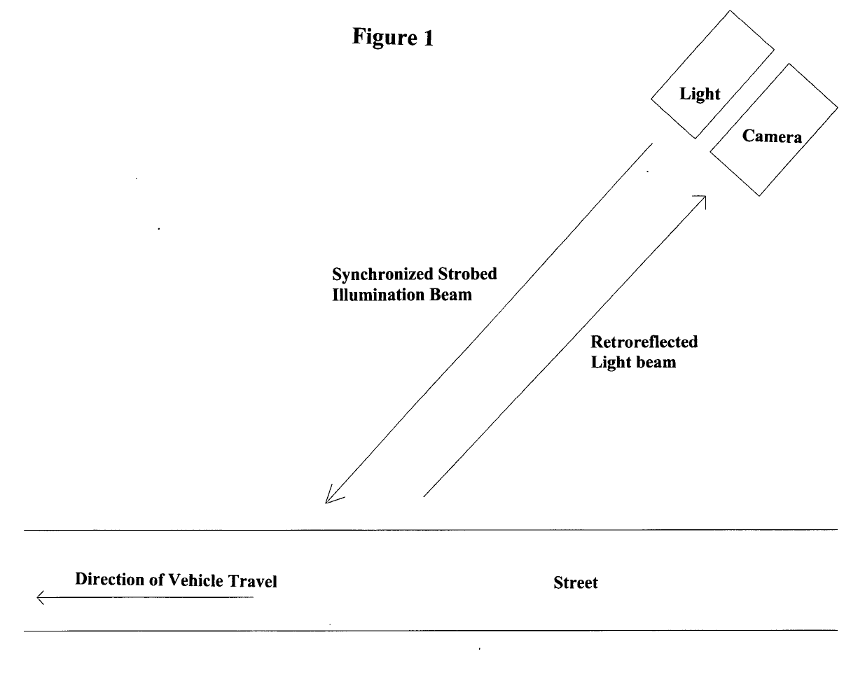

Since automobile tags are can be easily photographed stroboscopically, by using the vertical field pulses to initiate a flashing light, such as a high-powered LED array, and since ordinary and inexpensive video cameras operate at a field rate of about 60 fields per second, and since such cameras have limited resolution, a simple calculation shows that a car moving at 30 to 40 miles per hour may leave only a single stroboscopically acquired image upon passage. The general arrangement is illustrated in FIG. 1. If, using ordinary techniques, this image happens to be near the single point of intersection described in the above paragraph, then an adequate image of the tag will be obtained. If, however, the position of the vehicle is such that the tag is far to the left or right of this point, a blurry image will result. When extremely small angles are necessary, constrained by limits on where the camera may be mounted safely and securely, this can mean that a tag that is captured, indeed many tags that are captured, from passing vehicles will be far enough away from the ideal point to be unreadably out of focus. This effect is exacerbated under poor (low) lighting conditions, such as nighttime, when the width of the object region, otherwise known as the “depth of field” is very narrow because the optical aperture is very wide in order to admit a maximal amount of light.

In order to correct this situation, a very inexpensive correction can be made, and that is one of the techniques described in this patent, and here it is described.

As an example, a video camera is comprised of a dark box with a lens or pinhole at one end and a light sensitive sensor array at the other. The lens focuses an image onto the sensor array. Typical cameras have the array placed so that its planar surface has the axis through the center of the lens or through the center of the pinhole normal to itself. This results in an object region, as described earlier, that also has the axis through the center of the lens or pinhole normal to a plane at its rough center. This situation is shown in the arrangement depicted in FIG. 2.

In the case of videographing passing license plates, the angle that other considerations make necessary between the plane in which passing plates are to be found and the axis through the center of the pinhole or lens is not 90 degrees, but is some other angle. If we measure this angle in this application, we are measuring in a plane parallel to the earth.

Now if, instead of keeping the plane of the flat sensor surface in a position making the axis through the center of the lens or pinhole normal to it, we rotate the sensor mounting about a vertical axis so that the sensor is now, rather than being parallel to a plane normal to an axis through the lens or pinhole center, parallel to the street, we have corrected the focal distortion. This situation is shown in the arrangement depicted in FIG. 3.

The new object region intersects the street along a horizontal line parallel to the street, and tags passing by always remain in the new object region. This means that, no matter where the tag is in the image when the photo is taken, it will be in focus, rendering the entire field of view useful, and capturing a much higher number of readable tag numbers.

In addition to this, the image, when the sensor plane is rotated about a vertical axis, is stretched across the sensor, yielding higher horizontal resolution, and compensating for the resolution lost when the camera must look at the tag from an angle rather than straight on. A drawback is that the tag image passes the sensor faster so that this slows the maximum vehicle speed at which a tag capture can be guaranteed. However, this can be repaired by using a lens with a slightly reduced focal length, which increases the field of view dimensions in both the vertical and horizontal dimensions. Since auto tag numbers are typically far taller than wide, a great deal of reduction of focal length can be tolerated than might be expected, potentially enabling guaranteed capture of tags on automobiles traveling faster than 30-40 miles per hour, and increasing the vertical dimension of the field of view, thus allowing the camera to capture tags mounted at higher maximum heights while also capturing tags mounted at lower minimum heights.

Presently, as well, video cameras as described above are designed to use infrared lighting for several reasons. Prior art may be seen by referring to U.S. Pat. No. 7,016,518 and its listed predecessors. If strobing is not used, the light must be very bright and may interfere with the vision of drivers if an invisible form of light is not employed. However, the system I am describing here makes it useable at angles much closer to 90 degrees from the centerline of the road being viewed, thus removing it from direct view of drivers. Under these conditions, any color of light may be used for the illumination. Sometimes infrared radiation is used because it is desired that drivers be unaware that their tags are being photographed. Using visible light may act as a crime deterrent, particularly since the techniques described here are relatively inexpensive and may be purchased by individual homeowners. For CCD cameras, red light is the color of choice. Using red light allows the CCD sensor to be used at the wavelength of its peak sensitivity. This allows the use of filters in the image path to block other wavelengths, including infrared, and increasing the effectiveness of the illumination lamp where strobing the lamp is relied upon to freeze an image.

Finally, red LEDs, a popular source of pulsed light, can be operated at some twenty times their rated current and thus about 20 times their rated intensity if the duty cycle is low enough and if attention is given to heat management. Such LEDs are commercially available. Combining this with short pulsing of such LEDs in synchronization with the vertical field pulse available from processing the signals that video cameras produce can allow a video camera to freeze a moving tag both day and night. If enough strobed illumination is used, it will swamp the effects of vehicle-mounted tag lights so that the bulk of tag illumination originates from the strobed source and thus yields more consistent images of tags, ranging from those with no lights of their own or completely burned out tag lights to those with very bright tag lights. The use of infrared blocking filters and red pass filters in the image path helps the system use only the strobed light for imaging, and helps it ignore existing light from the automobile, which only serves to blur the image at night when the camera's AGC has slowed down its electronic shutter speed to gather enough light to produce an image.

### PREFERRED EMBODIMENT OF THE INVENTION

As mostly described above, I detail the preferred embodiment of this invention. Note that this in no way limits this invention as a method of obtaining license tag images, does not limit the color or type of strobed light source used, and does not place any other limits on the way this invention may be used.

When a victim of repeated crime needs evidence as to who is committing the crime but cannot afford to sit outside his home day and night to watch what is going on, it is helpful to be able to capture events using videography and, typically, a DVR. This allows flexible and high-quality recording of periods of several days of events that are happening in front of however many cameras are attached to the DVR.

Although a tag number of a car is not always considered definititive proof that a particular person was inside that car, it implies that and is thus useful in court under many circumstances. Additionally, this technology can be applied to photographing the person himself through auto glass.

This embodiment acquires images of auto tags.

The narrative below will become clearer by referring to FIGS. 1, 2, and 3.

Auto tags in the Unites States are coated with retro-reflective paint. This means that light is reflected preferentially back toward its source and not scattered all around. If the source of light is near the camera, then this condition is met and a relatively dim light source can yield acceptable images of auto tags. A camera and light source arrangement that takes advantage of this feature by being mounted near each other is illustrated in FIG. 1.

Typically, the automobile on which the tag is mounted is moving. Even low-light video cameras must increase their sensor exposure time in order to capture an image in very low lighting conditions. The darker the illumination of the object of interest is, the longer the exposure time must be. The longer the exposure time is, the more the object (tag) moves during the exposure, and the more smeared the image is.

To correct this problem, a light is mounted near the camera to take advantage of the retro-reflectivity of the tag coating. This light is of a type, such as an LED array, that is capable of producing short bursts of light, shorter than about 1/500 second. Circuitry is connected to the video output of the camera that contains a synchronization separator device, which is widely available, and a timing device that delays the generation of a pulse and then creates the fast pulse. This pulse is fed to a DC amplifier that drives a current limited driver transistor for the LED. Thus are produced extremely bright flashes of very short duration a little after each vertical field pulse from the camera. The details of this circuitry are beyond the scope of this patent.

These light pulses illuminate the tag, and much of that illumination returns back to the camera due to the retro-reflective coating on the tag. This illumination lasts such a short time that the tag is effectively frozen in motion. Even though the camera may have an exposure time as long as 1/60 second, the ambient nighttime light is so dim that this light does not register, while the short, bright burst does register and a clear image of the tag is obtained for each frame.

This is a continuously repeating process, occurring 60 times each second. The fact that the LED source is “on” for only about 1/1000 second every 1/60 second allows it to be driven far beyond its rated capability. The future is sure to bring more efficient pulsable light sources that need not be driven beyond their ratings, and it is always possible to add more LED arrays and drive them closer to their ratings if extreme reliability is desired and funding is available.

A red filter (cyan cutoff filter) of optical quality is placed in the image path of the camera. This filters out some of the white light emanating from any tag lights present on the automobile. In addition, an infrared cut filter is placed in the image path as well. This eliminates most of the infrared radiation from any incandescent tag lights on the automobile itself, which would cause blur if left in the image.

The paragraph below will become clearer by referring to FIGS. 2 and 3.

A final problem remains to be solved, and it, too, is related to having to get good photos under poor light conditions. In order to help increase the amount of light arriving at the image sensor in the camera, the aperture of the lens, which controls the amount of light entering the camera, should be at its widest opening. Unfortunately, the wider the opening the thinner the object region will be, as referred to above. The solution lies in building a camera with a rotatable mounting for the image sensor, or simply dismantling a standard camera and inserting shims on one side of the lens mount to effectively rotate the flat sensor surface plane.

Taken together, the techniques described above comprise a very effective system for capturing nearly every passing auto tag clearly enough for use by law enforcement, and inexpensively enough to be purchased by an individual homeowner.

What I claim is:

1. A camera comprised of a container into which light cannot enter except by way of a specific image-forming aperture at its front, an image-forming aperture at the front of said container that admits light, and an image-sensitive surface closer to its rear, the plane of which can be rotated about either a vertical line or a about a horizontal line or about both a vertical and a horizontal line so that the plane of said image-sensitive surface is no longer parallel to the front face of the box.

2. A camera, as in claim 1, in which the image-sensitive surface closer to the rear of the camera is a flat holder for photographically sensitive film.

3. A camera, as in claim 1, in which the image-sensitive surface closer to the rear of the camera is the light-sensitive surface of any array of electronic light detectors.

4. A camera, as in claim 2, which contains no, any, or all available means of controlling focus, image magnification, and image-sensitive surface light exposure time whether manually or automatically.

5. A camera, as in claim 3, which contains no, any, or all available means of controlling focus, image magnification, and image-sensitive surface light exposure time, whether manually or automatically.

6. A camera, as in claim 1, in which the rotation of the plane of the image-sensitive surface is controlled by opening the camera body, adjusting one or a plurality of electrical or mechanical settings, and then closing the camera body.

7. A camera, as in claim 1, in which the rotation of the plane of the image-sensitive surface is controlled by one or a plurality of electrical or mechanical settings accessible without opening the camera body.

8. A camera, as in claim 1, in which the rotation of the plane of the image-sensitive surface is controlled by one or a plurality of electrical or mechanical settings that are conveyed to the camera by externally provided electronic control, whether automatically or manually generated.

9. A camera, as in claim 1, the light-admitting device of which contains an electromechanically adjustable iris, which is connected to circuitry that sets, according to the position of any type of switch, a daytime iris size and a nighttime iris size.

10. A camera, as in claim 1, arranged so that its artificial light source operates only at night when the iris size is at a particular setting, and which does not operate in the daytime, when the iris size is at its daytime setting.

11. A system, as in claim 10, which, when aimed at the position of an object that is expected to be passing at a velocity such as to blur the image of an ordinary camera, captures an image or a plurality of clear images that may be recorded.

12. A system, as in claim 1, which captures images of the license plate numbers of rapidly passing vehicles both day and night.

13. A system, as in claim 10, which captures images of the license plate numbers of rapidly passing vehicles both day and night.
